(19) United States
(12) Patent Application Publication
(10) Pub. No.: US 2024/0051896 A1
(43) Pub. Date: Feb. 15, 2024

(54) METHODS OF FORMING LOW SALT NITROGEN-BASED FERTILIZER

(71) Applicant: Cynagra LLC, Twin Falls, ID (US)

(72) Inventor: Mark Folkman, Twin Falls, ID (US)

(21) Appl. No.: 18/232,297

(22) Filed: Aug. 9, 2023

Related U.S. Application Data
(60) Provisional application No. 63/396,958, filed on Aug. 10, 2022.

(51) Int. Cl. C07B 43/02; C05C 11/00

(52) U.S. Cl. CPC C07B 43/02; C05C 11/00

(57) ABSTRACT

A method of forming a fertilizer can include three steps: (1) hydrolyzing a starting material to form a hydrolyzed carbon compound; (2) infusing the hydrolyzed carbon compound with nitrogen under high temperature and high pressure to form a nitrogen-infused compound; and (3) oxidizing the nitrogen-infused compound to form the fertilizer. The starting material can be a compound that has a carbon-carbon bond and/or a carbon-hydrogen bond, and in some examples the starting material is a waste or by-product, such as leftover animal feed or plastics. The fertilizer can have a low salt index.

### CROSS REFERENCE TO RELATED MATTER

The present application claims the benefit of and priority to U.S. Provisional Application No. 63/396,958, entitled METHODS OF FORMING LOW SALT NITROGEN-BASED FERTILIZER and filed on Aug. 10, 2022, the entire contents of which are herein incorporated by reference.

### TECHNICAL FIELD

The present disclosure relates generally to methods of forming a fertilizer. More specifically, the disclosure relates to a method of forming a low-salt nitrogen-based fertilizer.

### DESCRIPTION OF THE RELATED ART

Nitrogen fertilizer has been a necessary commodity for high-producing agricultural operation for centuries. The Haber-Bosch process is widely known and used, where nitrogen and hydrogen molecules react to form ammonia (N₂+6H₂→2NH₃). Hydrogen is produced onsite via methane steam reforming (CH₄+H₂O→CO+3H₂) in combination with the water-gas shift reaction (CO+H₂O→CO₂+H₂). Nitrogen and hydrogen combine in a high-pressure reactor with the aid of an iron-based catalyst. More than 12.6 million tons of nitrogen fertilizer are produced each year because of this manufacturing process.

The Haber-Bosch process uses natural gas (methane) to produce ammonia. From ammonia, a multitude of other nitrogen-based fertilizer compounds are then produced. Though this process is generally efficient, it also produces compounds that have a high salt content, limiting the use of these types of fertilizers by the amount of salt allowed by the soil and the crop grown. Ammonium-based fertilizers with high salt contents can do significant damage to crops if misapplied. When applied to the soil, ammonium-based fertilizers can burn the crop seed and damage the surrounding soil due to the higher salt index.

Another drawback of the Haber-Bosch process is the use of natural gas (methane), which is not a renewable, carbon neutral material. The Haber-Bosch process accounts for 1.4% of global carbon dioxide emissions and consumes 1% of the world's total energy production. The cost of natural gas is volatile depending on source availability and economics, and can also be hazardous to handle and process.

Another process for producing nitrogen fertilizer is the Birkeland-Eyde process developed in Norway and used only briefly due to the greater efficiency of the Haber-Bosch process. It involves the use of electrical arcs to ionize the nitrogen molecule and through the addition of water eventually make a form of nitric acid. From nitric acid, nitrates are produced and used as a fertilizer. Fertilizers of this form are also high in salt content and are not renewable.

Accordingly, while progress has been made in this field, there remains a need in the art for improved methods of producing nitrogen-based fertilizers which are efficient to manufacture and safe for the crop and the environment.

### BRIEF SUMMARY

In brief, embodiments of the disclosure provide methods of forming a nitrogen-containing fertilizer. In one example, the method includes preparing a starting material by grinding the starting material into a powder to increase surface area (e.g., available surface area) for further processing and to form a prepared starting material, wherein the starting material is selected from the group of corn, wood, carbohydrates, plastics, and oils; hydrolyzing the prepared starting material, by applying heat and pressure to a reaction vessel containing the prepared starting material and water, to form a hydrolyzed carbon compound; ionizing nitrogen gas using an electric-magnetic ionization system to form ionized nitrogen; transferring the hydrolyzed carbon compound into a nitrogen infusion reactor; infusing the hydrolyzed carbon compound with the ionized nitrogen in a reaction vessel under high temperature and high pressure to form a nitrogen-infused compound; transferring the nitrogen-infused compound into an oxidation reactor and oxidizing the nitrogen-infused compound to form the nitrogen-containing fertilizer; and separating molecules within the nitrogen-containing fertilizer based on a size of the molecules and packaging smaller-sized molecules as a final fertilizer product. Hydrolyzing the prepared starting material by applying heat and pressure to the reaction vessel containing the prepared starting material can comprise applying a heat of about 25 to about 900 degrees Celsius and applying a pressure of about 2 atm to about 1000 atm. In some configurations, a heat of about 25 to about 450 degrees Celsius is applied and a pressure of about 68 atm to about 1000 atm is applied. Transferring the hydrolyzed carbon compound into a nitrogen infusion reactor can comprise transferring the hydrolyzed carbon compound under high heat and high pressure.

Infusing the hydrolyzed carbon compound with the ionized nitrogen in a reaction vessel under high temperature and high pressure can comprise subjecting the reaction vessel to a temperature of at least 250 degrees Celsius and a pressure of at least 80 atmospheres. Or a temperature of at least 25 degrees Celsius and a pressure of at least 1000 atm can be used.

In some examples, the final fertilizer product has a salt index of less than 40. In other examples, the final fertilizer product has a salt index of about 5 to about 40.

According to another exemplary configuration, a method of forming a fertilizer can comprise hydrolyzing a starting material, the starting material including at least one of a carbon-carbon bond and a carbon-hydrogen bond, to form a hydrolyzed carbon compound; infusing the hydrolyzed carbon compound with nitrogen under high temperature and high pressure to form a nitrogen-infused compound; and oxidizing the nitrogen-infused compound to form the fertilizer. The starting material can contain at least one of: an alkane, an alkene, an alkyne, an aromatic ring structure, a carboxyl, a carbonyl, an acyl, an alcohol, a phenol, an amine, a carbohydrate, a polyethylene, a plastic material such as a HDPE, LDPE, PP, PS, PET, PVC, PC, Polyamide, PU, PBT, PLA, PMMA, POM, PPO, PVA, SB, and a heterocyclic compound.

According to yet another aspect, a fertilizer is formed by the following method: hydrolyzing a starting material, the starting material comprising at least one of a carbon-carbon bond and a carbon-hydrogen bond, to form a hydrolyzed carbon compound; infusing the hydrolyzed carbon compound with nitrogen under high temperature and high pressure to form a nitrogen-infused compound; and oxidizing the nitrogen-infused compound to form the fertilizer.

According to another example, a nitrogen-based fertilizer is described and can comprise a hydrolyzed carbon molecule infused with nitrogen, wherein the nitrogen-based fertilizer has a salt index from between about 5 to about 40.

These and other aspects of the invention will be apparent upon reference to the following detailed description.

### BRIEF DESCRIPTION OF DRAWINGS

The drawings are illustrative and not limiting of the scope of the disclosure which is defined by the appended claims. The various elements of the invention accomplish various aspects and objects of the invention. Not every element of the invention can be clearly displayed in a single drawing, and as such not every drawing shows each element of the invention. The components in the drawings are not necessarily to scale relative to each other. Like reference numerals designate corresponding parts throughout the several views.

FIG. 1 is schematic of an exemplary process that can be used according to the methods described herein.

FIG. 2 is a schematic view of an exemplary system of reactors that can be used with the methods described herein.

### DETAILED DESCRIPTION

In the following description, certain specific details are set forth in order to provide a thorough understanding of various embodiments of the invention. However, one skilled in the art will understand that the invention may be practiced without these details.

Unless the context requires otherwise, throughout the present specification and claims, the word “comprise” and variations thereof, such as, “comprises” and “comprising” are to be construed in an open, inclusive sense, that is, as “including, but not limited to”.

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

“Alkyl” refers to a straight or branched hydrocarbon chain radical consisting solely of carbon and hydrogen atoms, which is saturated or unsaturated (i.e., contains one or more double and/or triple bonds), having from one to twelve carbon atoms (C₁-C₁₂ alkyl), such as one to eight carbon atoms (C₁-C₈ alkyl) or one to six carbon atoms (C₁-C₆ alkyl), and which is attached to the rest of the molecule by a single bond, e.g., methyl, ethyl, n-propyl, 1-methylethyl (iso-propyl), n-butyl, n-pentyl, 1,1-dimethylethyl (t-butyl), 3-methylhexyl, 2-methylhexyl, ethenyl, prop-1-enyl, but-1-enyl, pent-1-enyl, penta-1,4-dienyl, ethynyl, propynyl, butynyl, pentynyl, hexynyl, and the like. Alkyl includes alkenyls (one or more carbon-carbon double bonds) and alkynyls (one or more carbon-carbon triple bonds such as ethynyl and the like).

“Alkylene” or “alkylene chain” refers to a straight or branched divalent hydrocarbon chain linking the rest of the molecule to a radical group, consisting solely of carbon and hydrogen, which is saturated or unsaturated (i.e., contains one or more double and/or triple bonds), and having from one to twelve carbon atoms, e.g., methylene, ethylene, propylene, n-butylene, ethenylene, propenylene, n-butenylene, propynylene, n-butynylene, and the like. The alkylene chain is attached to the rest of the molecule through a single or double bond and to the radical group through a single or double bond. The points of attachment of the alkylene chain to the rest of the molecule and to the radical group can be through one carbon or any two carbons within the chain. Unless stated otherwise specifically in the specification, an alkylene chain is optionally substituted.

“Carbohydrate” refers to any naturally occurring compound, or a derivative of such a compound, with the general chemical formula Cₓ(H₂O)_{y}, where x and y can be any suitable number. Carbohydrates can include, but are not limited to, monosaccharides, disaccharides, oligosaccharides, and polysaccharides.

“Alcohol” refers to any compound that carries at least one hydroxyl functional group (—OH) bound to a saturated carbon atom.

“Nitrogen-based” means any compound or chemical that contains a nitrogen atom.

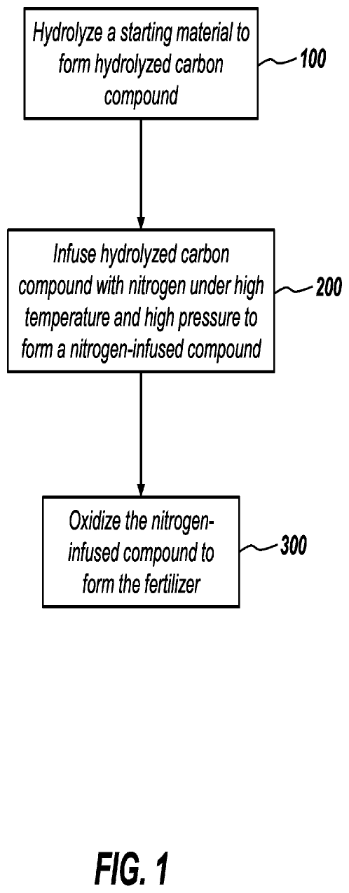

According to one aspect, a method involves a process of producing a low salt-carbohydrate based nitrogen fertilizer for use commercially. The low-salt fertilizer can be formed from renewable starting materials, such as wood chips, corn compost, etc. In general, the steps are shown in FIG. 1 and can include: (1) hydrolyzing the starting material (step 100); (2) inserting nitrogen into the hydrolyzed starting material (step 200); and (3) oxidation under heat and pressure to form a long-chain nitrogen fertilizer compound (step 300).

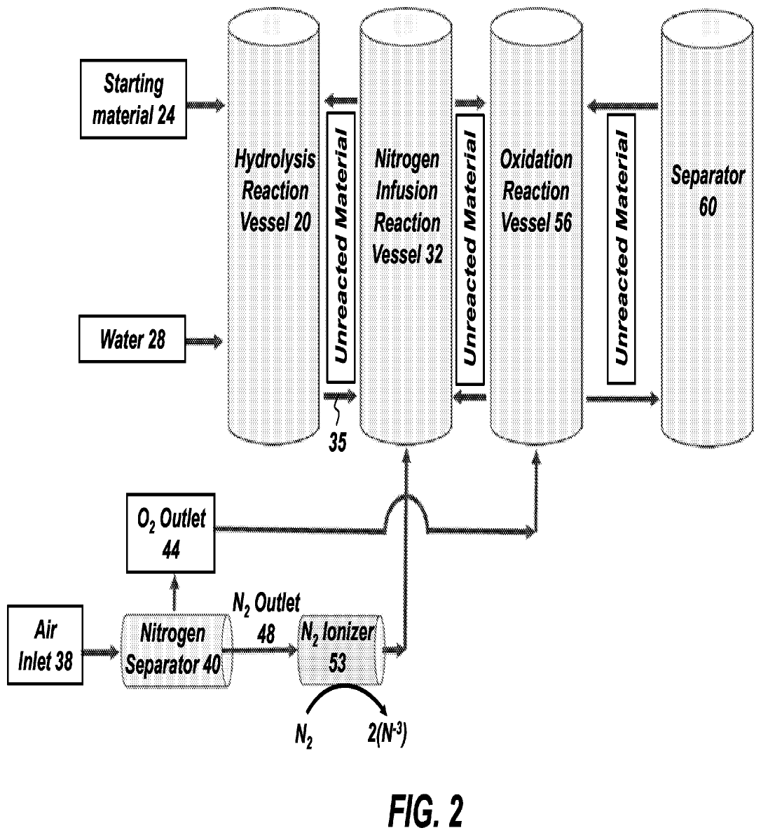

FIG. 2 shows a diagram of an exemplary set of reaction vessels that could be used in a process to form a low-salt, nitrogen-based fertilizer. According to FIG. 1, separate reaction vessels are provided for the hydrolysis step, the nitrogen infusion step, the oxidation step, and the purification step. In other configurations, one or more of these steps can be performed in the same reaction vessel.

### Hydrolyzing the Starting Material

According to one aspect, a starting material can first be prepared. The list of raw materials that can be used for starting material is extensive and includes corn, straw, wood, etc. In some examples, any material with a carbon-hydrogen or carbon-carbon bond can be used to produce a nitrogen-based fertilizer according to the process described herein. In other examples, the starting material includes a carbon-hydrogen or carbon-carbon bond that can be hydrolyzed using water, high temperatures, and/or high pressures. Other options to improve the hydrolysis reaction can include use of microwaves, enzymes, or other known processes. Feedstock containing the carbon-hydrogen bond can include but is not limited to wood, corn, leftover animal feed ingredients, starches, oils (natural and synthetic), sugars, straw, ash, carbohydrates, plastics, and any recyclable material with a carbon-carbon or carbon-hydrogen bond.

Materials used for starting materials can be chemicals other than carbon-based chemicals, but typically should contain at least one carbon-carbon or carbon-hydrogen bond. For example, starting materials can include materials containing alkyls, alkenes, alkyne, alkylenes, alkylene chains, aromatic ring structures, carboxyl compounds, carbonyl groups, acyl groups, monomeric alcohols and phenols, amines, monosaccharides, disaccharides, polysaccharides, heterocyclic compounds, or chemicals containing other bonds or groups attached to a carbon-carbon or carbon-hydrogen bond. Other starting materials with chemical groups not directly associated with carbon-carbon or carbon-hydrogen bonds may be connected to a carbon-carbon or a carbon-hydrogen bond. In some examples, materials in solid form can be prepared, such as by grinding, to be used as a starting material. For example, wood, corn, etc., can be ground to a small powder to increase surface area prior to hydrolysis.

After the optional step of preparing a starting material, the starting material 24 can be placed into a hydrolysis reaction vessel 20 (FIG. 2). In addition to adding the starting material 24, water 28 can also be added to the hydrolysis reaction vessel 20. Heat and/or pressure can be applied to the hydrolysis reaction vessel 20 to increase the rate of hydrolysis. Hydrolysis can occur under multiple temperatures and pressures, and the disclosure herein is not limited to any particular pressure or temperature. Pressures and temperatures are given by way of example and not limitation as those of skill in the art can optimize reaction conditions for things such as time, cost, and effectiveness. In some examples, heat can be applied, such as a heat from about 25° C. to about 900° C., or from about 100° C. to about 500° C., or from about 200° C. to about 400° C., or about 315° C. In some examples, pressure or high pressure applied may be around 2 atm to around 1000, around 500 atm to around 2000 atm, or over 1000 atm or around 1500 atm. In some examples, an acid or base catalyst can be used for hydrolysis. An acid or base catalyst can be used in addition to heat and/or pressure and/or enzymes.

The hydrolysis reaction can be generally described by the following equation to express hydrolysis of a carbon-carbon bond:

R′—C—C—R″+H₂O--->R′—C—OH+H—C—R″

Where R′ or R″ can be any carbon-carbon or carbon-hydrogen molecule or structure. The reaction can be generally described by one of the following equations for hydrolysis of a compound with a carbon-hydrogen bond:

R′—C—C+H₂O--->R′—C—OH+C(H)₄

R′—C—C+H₂O--->R′—C—C—OH+H

R′—C—C—R″+H₂O--->R′—C—OH+R″—C—H

Where R′ or R″ can be any carbon-carbon or carbon-hydrogen molecule or structure.

After hydrolysis, the hydrolyzed carbon compounds can be transferred from the hydrolysis reaction vessel 20 into a nitrogen infusion reaction vessel 32, as indicated by arrow 35. In some examples, the nitrogen infusion reaction vessel 32 can be connected or otherwise coupled to the hydrolysis reaction vessel 20. Or, in other examples, the nitrogen infusion reaction vessel 32 is not connected to the hydrolysis reaction vessel 20. In yet other examples, both hydrolysis and nitrogen infusion can occur in the same reaction vessel.

### Nitrogen Infusion

Nitrogen can first be prepared by separation and/or ionization. For example, nitrogen can be separated from the atmosphere using membrane nitrogen generation, pressure swing adsorption, cryogenic distillation, and/or other technologies. Any suitable membrane separators or other relevant technologies, known in the art now or discovered in the future, can be used to separate the nitrogen from the atmosphere. In the exemplary configuration of FIG. 2, an air inlet 38 is in fluid communication or otherwise in connection with a nitrogen separator 40. The nitrogen separator 40 separates both oxygen and nitrogen from atmospheric air. The oxygen outlet 44 can be in connection with an oxidation reaction vessel as described in more detail below. The nitrogen outlet 48 can be in connection with a nitrogen ionizer 53. Or in other examples, nitrogen can be purchased rather than separated from atmospheric air.

In some examples, after the nitrogen is purchased or isolated from the atmosphere, such as by the nitrogen separator 40, the nitrogen can be ionized. Any suitable ionization method can be used. In some examples, nitrogen gas can be ionized using an electric-magnetic ionization system. Ionizing the nitrogen gas can make the next step of the process (which involves nitrogen bonding) more efficient. A catalyst, such as a copper catalyst or other metallic catalyst, can be used to assist the reaction of ionizing the N₂ molecule. The ionization process can generally be expressed as:

N₂--->2(N⁻³)

A nitrogen ionizer 53 can be used and can also be in communication with a nitrogen infusion reaction vessel 32. In other examples, the nitrogen is not ionized. Nitrogen can also be prepared for infusion by the use of a KFr Laser with sufficient size and output to react with the nitrogen gas and form a gas consisting of ionized atoms of nitrogen which can then react with the hydrolyzed carbon-hydrogen material without the use of an electric arc. In addition, nitrogen gas can be ionized through high temperatures and pressures sufficient to add 3.3 MV/m into the gas. It may be simpler and less expensive to use an electric arc to ionize nitrogen.

Within the nitrogen infusion reaction vessel 32, nitrogen can be injected into the hydrolyzed carbon compounds. Nitrogen introduced into the nitrogen infusion reaction vessel 32 combines with the hydrolyzed carbon compounds and forms a combination of carbon-nitrogen-oxygen bonds. In some examples, the nitrogen is infused under high temperature and/or high pressure. Microwaves, enzymes, and/or catalysts, etc. can also be used to effectively complete the reaction. The reaction can generally be described as:

2(N⁻³)+2(R′—C—OH)--->2(R′—C—NO)+H₂ or

2(N⁻³)+2(R′—C—C—R″—(OH))--->2(R′—C—C—R″—NO)+H₂

Where R′ or R″ can be any carbon-carbon or carbon-hydrogen molecule or structure.

### Oxidation Form a Long-Chain Nitrogen Case Fertilizer Compound

After nitrogen infusion, the materials can be pumped or otherwise moved or transferred into an oxidation reaction vessel 56. Or in other examples, this oxidation step can take place in the same reaction vessel as one or more of the previous steps described above. Oxygen is injected into the materials and the oxidation reaction can generally be described as:

2(R′—C—NO)+O₂--->2(R′—C—NO_{X})+Unreacted Material

Where R′ can be any carbon-carbon or carbon-hydrogen molecule or structure. Unreacted material may contain any carbon-hydrogen material not containing at least one nitrogen atom (such as any ash, minerals, or dirt in the starting materials), material not fully reacted with nitrogen, or material still remaining not fully oxidized. The unreacted material generated by this step can be moved to one or more of the previous steps described above (i.e., hydrolysis, nitrogen infusion) and subjected to the process again, or otherwise properly disposed of.

Optionally, the oxidized material can be moved into one or more separators 60. Separation can occur, for example, by separating the compounds by size. Completed product (e.g., fully reacted material) can be separated from unusable product (e.g., unreacted material) using separation and filtering steps. For example, a multistage separation process can be used. Typically, product separated and filtered for final shipping will be mostly smaller sized molecules derived from the hydrolysis process. These smaller molecules will generally give a higher nitrogen content without producing a handling hazard. Filtering steps may include packed columns where acceptable material will be separated at a higher level in the column, through membrane separators, liquid-liquid extraction columns, fractional distillation, centrifugation, screens, molecular sieves, coalescers, etc.

Throughout the process, unreacted material can be sent upstream or downstream. For example, product that is oxidized but separated out as being too large for final shipping and drying can be moved to the hydrolysis reaction vessel 20, the nitrogen infusion reaction vessel 32, and/or the oxidation reaction vessel 56. Remaining material can be returned to the reactor for further hydrolysis, nitrogen infusion, or oxidation.

The nitrogen-based fertilizer can also be dried as needed for shipping and application purposes. Waste material such as minerals and contaminates will be properly disposed of. In some examples, the nitrogen-based fertilizer formed according to the methods described herein contains very little ammonium nitrate, ammonia, and/or urea. In other examples, the nitrogen-based fertilizer contains no ammonium nitrate. The nitrogen-based fertilizer described herein also has a low salt index. Salt index is the increase in osmotic pressure resulting from addition of fertilizer to a solution, relative to effect of the same amount of NaNO₃ (SI=100), where sodium nitrate is assigned a relative value of 100. In other words, the salt index is calculated by comparing the increase in osmotic potential brought about by addition of that fertilizer material compared to the increase in osmotic potential when an equivalent weight of sodium nitrate is added to water. The salt index of a mixed fertilizer containing N, P and K is the sum of the salt index values (partial salt index) of its components. The salt index of sodium nitrate is defined as 100. Fertilizer materials with salt indices greater than 100 produce an osmotic potential greater than an equal weight of sodium nitrate. Fertilizers with salt index values less than 100 produce an osmotic potential less than an equal weight of sodium nitrate.

A nitrogen-based fertilizer formed by the methods described herein can have a salt index of less than 45, less than 40, less than 35, less than 30, less than 25, less than 20, less than 15, less than 10, or less than 5. In some examples, a hydrolyzed carbon molecule infused with nitrogen and used as a nitrogen-based fertilizer has a salt index from between about 5 to about 40. Where the salt index is expressed per unit of nitrogen, the salt index of the fertilizer formed by the method described herein can be less than 250 per unit of nitrogen, less than 200 per unit of nitrogen, less than 150 per unit of nitrogen, or less than 100 per unit of nitrogen.

### Working Example 1: Corn as Starting Material

Corn can be used as one example of a starting material with a carbon-hydrogen source available for hydrolysis and nitrogen infusion. As a starting material, the corn can first be prepared. The preparation can involve, for example, cleaning the corn and/or grinding it to a powder using a hammer mill or any other suitable method of grinding corn. The corn can be ground to any suitable level, and in some examples the corn is ground to a coarse powder and in other examples the corn is ground to a fine powder. After the corn starting material is prepared, it can be introduced into a reaction vessel. Or in some examples, the preparation can be skipped and the corn can be introduced into a reaction vessel without washing and/or grinding. Any suitable reaction vessel can be used, such as a main reactor vessel or another reaction vessel.

Next, water is added, usually around 2.5 times the amount of corn being hydrolyzed on a weight basis (water is typically in excess). The prepared corn starting material is added to the reaction vessel with the water to drive hydrolysis of the prepared corn starting material. This reaction can be expressed as:

R′—C—C—R″+H₂O--->R′—C—OH+R″—C—H (water in excess)

Where R′ or R″ is a carbon-based compound of the prepared corn starting material. (Other starting materials can be used, and corn is given here just by way of example.) Corn is generally broken down into the following chemical groups: 73% of the corn is starch, fiber is generally 9%, with the remainder as a combination of protein, other carbohydrates, oil, and ash. After water is added to the prepared corn starting material in the reaction vessel, heat and pressure are applied to the reaction vessel to drive hydrolysis of the prepared corn starting material. In one example, heat of about 315 degrees Celsius and a pressure of about 102 atm (1500 psi) are applied to the reaction vessel.

After the hydrolysis of the corn starting material, it can then be pumped or otherwise moved from the initial reaction vessel to a second reaction vessel for nitrogen infusion. In other examples, the hydrolysis and the nitrogen infusion can take place in the same reaction vessel. In one example the hydrolyzed carbon compound is pumped into a nitrogen infusion reaction vessel under pressure and heat.

In the nitrogen infusion reaction vessel, ionized nitrogen is injected. The nitrogen can be isolated and ionized in any suitable manner known in the art. For example, nitrogen can be separated from the atmosphere using membrane nitrogen generation, pressure swing adsorption, or cryogenic distillation or other useful technology. Any suitable membrane separators or other relevant technologies, known in the art now or discovered in the future, can be used to separate the nitrogen from the atmosphere. Or in other examples, nitrogen can be purchased.

After the nitrogen is isolated from atmosphere (or purchased), it can be ionized. For example, the nitrogen gas can be ionized using an electric-magnetic ionization system. A catalyst, such as a copper catalyst or other metallic catalyst, can be used to assist the reaction of ionizing the N₂ molecule. The ionization process can generally be expressed as:

N₂--->2(N⁻³)

In the nitrogen infusion reaction vessel, ionized nitrogen is injected until nitrogen saturation is complete. The nitrogen can be injected under high temperatures and high pressures to force the reaction to take place. Nitrogen infusion can generally be expressed as:

2(N⁻³)+2(R′—C—OH)--->2(R′—C—NO)+H₂ or

2(N⁻³)+2(R′—C—C—R″—(OH))--->2(R C—C—R″—NO)+H,

Where R′ or R″ can be any carbon-carbon or carbon-hydrogen molecule or structure in the corn starting material After nitrogen saturation is complete, the raw material from the nitrogen infusion reaction vessel can be moved to an oxidation vessel. Or oxidation can occur in the same reaction vessel.

In the oxidation vessel, oxygen is injected and heat and pressure can be applied to cause oxidation of the nitrogen-infused carbon compounds. The reaction can generally be described as:

2(R′—C—NO)+O₂--->2(R′—C—NOₓ)+Unreacted Material

Where R′ can be any carbon-carbon or carbon-hydrogen molecule or structure, and NOₓ is a nitrogen oxide, nitrogen dioxide, nitrate or any combination thereof. This oxidized, nitrogen-infused carbon compound forms a nitrogen-based fertilizer. Unreacted material can be a by-product of this reaction and can be used in several ways. For example, unreacted material can be returned to the first reaction vessel to undergo further hydrolysis, nitrogen infusion, and/or oxidation. Any waste materials, such as minerals and contaminates can be properly disposed of and/or recycled in another process.

After the nitrogen-based fertilizer is formed, it can be further separated and refined. Filtering steps may include packed columns where acceptable material will be separated at a higher level in the column, through membrane separators, liquid-liquid extraction columns, fractional distillation, centrifugation, coalescers, etc. The nitrogen-based fertilizer can undergo a multistage separation process to form the final product for shipping. The product may be separated based on size of the molecules, with product separated for final shipping being mostly smaller-sized molecules. Additionally, the end product is typically in liquid form and can be dried and packaged for shipping and application.

### Working Example 2: Wood Hydrolysis

In another example, wood can also be hydrolyzed and reacted to make a low salt nitrogen fertilizer. Wood can be used as one example of a starting material with a carbon-hydrogen source available for hydrolysis and nitrogen infusion. Wood can be from any source including trees of various types, cut lumber, wood chips, saw dust, both soft and hard woods, woody plants, and any plant material containing a cellulose chemical structure. As a starting material, the wood can first be prepared. The preparation can involve, for example, cleaning the wood and/or grinding it to a powder using a hammer mill or any other suitable method of grinding wood. The wood can be ground to any suitable level, and in some examples the wood is ground to a coarse powder and in other examples the wood is ground to a fine powder. After the wood starting material is prepared, it can be introduced into a reaction vessel. Or in some examples, the preparation can be skipped and the wood can be introduced into a reaction vessel without washing and/or grinding. Any suitable reaction vessel can be used, such as a main reactor vessel or another reaction vessel.

Next, water is added usually 5 times the amount of wood being hydrolyzed on a weight basis (water in excess). The prepared wood starting material is added to the reaction vessel with the water to drive hydrolysis of the prepared wood starting material. Wood is mostly cellulose but contains the following amount of other chemicals: Cellulose (about 50%), Hemicellulose (about 15-25%), Lignin (about 15-30%), and other various chemicals and minerals.

Cellulose (the main chemical) formula can be expressed as follows: (C₆H₁₀O₅)ₙ where n is the number of polysaccharide units.

Broken down, the reaction can be illustrated below:

R′—C—C—R″+H₂O--->R′—C—OH+R″—C—H (water in excess)

Where R′ or R″ represents any location along the carbon-based or Beta (1-4) units of the linked D-glucose molecule (i.e., the cellulose) of the prepared wood starting material. After water is added to the prepared wood starting material in the reaction vessel, heat and pressure are applied to the reaction vessel to drive hydrolysis of the prepared wood starting material. In one example, heat of about 600 degrees Celsius and a pressure of about 300 atm are applied to the reaction vessel.

After the hydrolysis of the wood starting material, it can then be pumped or otherwise moved from the initial reaction vessel to a second reaction vessel for nitrogen infusion. In other examples, the hydrolysis and the nitrogen infusion can take place in the same reaction vessel. In one example the hydrolyzed carbon compound is pumped into a nitrogen infusion reaction vessel under pressure and heat.

In the nitrogen infusion reaction vessel, ionized nitrogen is injected. The nitrogen can be isolated and ionized in any suitable manner known in the art. For example, nitrogen can be separated from the atmosphere using membrane nitrogen generation, pressure swing adsorption, or cryogenic distillation or other useful technology. Any suitable membrane separators or other relevant technologies, known in the art now or discovered in the future, can be used to separate the nitrogen from the atmosphere. Or in other examples, nitrogen can be purchased.

After the nitrogen is isolated from atmosphere (or purchased), it can be ionized. For example, the nitrogen gas can be ionized using an electric-magnetic ionization system. A catalyst, such as a copper catalyst or other metallic catalyst, can be used to assist the reaction of ionizing the N₂ molecule. The ionization process can generally be expressed as:

N₂--->2(N⁻³)

In the nitrogen infusion reaction vessel, ionized nitrogen is injected until nitrogen saturation is complete. The nitrogen can be injected under high temperatures and high pressures to force the reaction to take place. Nitrogen infusion can generally be expressed as:

2(N⁻³)+2(R′—C—OH)--->2(R′—C—NO)+H₂ or

2(N⁻³)+2(R′—C—R″—(OH))-->2(R′—C—C—R″—NO)+H₂

Where R′ or R″ can be any carbon-carbon or carbon-hydrogen molecule or structure in the wood starting material. After nitrogen saturation is complete, the raw material from the nitrogen infusion reaction vessel can be moved to an oxidation vessel. Or oxidation can occur in the same reaction vessel.

In the oxidation vessel, oxygen is injected and heat and pressure can be applied to cause oxidation of the nitrogen-infused carbon compounds. The reaction can generally be described as:

2(R′—C—NO)+O₂--->2(R′—C—NOₓ)+Unreacted Material

Where R′ can be any carbon-carbon or carbon-hydrogen molecule or structure, and NOₓ is a nitrogen oxide, nitrogen dioxide, nitrate or any combination thereof. This oxidized, nitrogen-infused carbon compound forms a nitrogen-based fertilizer. Unreacted material can be a by-product of this reaction and can be used in several ways. For example, unreacted material can be returned to the first reaction vessel to undergo further hydrolysis, nitrogen infusion, and/or oxidation. Any waste materials, such as minerals and contaminates can be properly disposed of and/or recycled in another process.

After the nitrogen-based fertilizer is formed, it can be further separated and refined. Filtering steps may include packed columns where acceptable material will be separated at a higher level in the column, through membrane separators, liquid-liquid extraction columns, fractional distillation, centrifugation, coalescers, etc. The nitrogen-based fertilizer can undergo a multistage separation process to form the final product for shipping. The product may be separated based on size of the molecules, with product separated for final shipping being mostly smaller-sized molecules. Additionally, the end product may be in liquid form and can be dried and packaged for shipping and application.

Unless defined otherwise, all technical and scientific terms used herein have the same meaning as is commonly understood by one of skill in the art to which this invention belongs. As used in the specification and claims, the singular form “a”, “an” and “the” include plural references unless the context clearly dictates otherwise. The phrase “in one example” does not necessarily limit the inclusion of a particular element of the invention to a single configuration, rather the element may be included in other or all configurations discussed herein.

As used herein, the term “generally” refers to something that is more of the designated adjective than not, or the converse if used in the negative. As used herein, the term “about” is used to provide flexibility to a numerical range endpoint by providing that a given value may be “a little above” or “a little below” the endpoint while still accomplishing the function associated with the range, for example, “about” may be within 10% of the given number or given range. As used herein, a plurality of items, structural elements, compositional elements, and/or materials may be presented in a common list for convenience. However, these lists should be construed as though each member of the list is individually identified as a separate and unique member.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 5 to about 60” should be interpreted to include not only the explicitly recited values of about 5 to about 60, but also include individual values and sub-ranges within the indicated range. Thus, included in this numerical range are individual values such as 5, 6, 7, 8, 9, etc., through 60, and sub-ranges such as from 10-20, from 30-40, and from 50-60, etc., as well as each number individually. This same principle applies to ranges reciting only one numerical value as a minimum or a maximum. Furthermore, such an interpretation should apply regardless of the breadth of the range or the characteristics being described. Additionally, the words “connected” and “coupled” are used throughout for clarity of the description and can include either a direct connection or an indirect connection.

While methods are described herein in discrete steps in a particular order for the sake of clarity, the steps do not require a particular order and more than one step may be performed at the same time. For example, a later step may begin before earlier step completes. Or a later step may be completed before an earlier step is started.

### Aspects of the Disclosure

Aspect 1: A method of forming a nitrogen-containing fertilizer, the method comprising:
preparing a starting material by grinding the starting material into a powder to increase surface area for further processing and to form a prepared starting material, wherein the starting material is selected from the group of corn, wood, carbohydrates, alcohols, plastics, and oils;
hydrolyzing the prepared starting material by applying heat and pressure to a reaction vessel containing the prepared starting material and water, to form a hydrolyzed carbon compound;
ionizing nitrogen gas using an electric-magnetic ionization system to form ionized nitrogen;
transferring the hydrolyzed carbon compound into a nitrogen infusion reactor;
infusing the hydrolyzed carbon compound with the ionized nitrogen in a reaction vessel under high temperature and high pressure to form a nitrogen-infused compound;
transferring the nitrogen-infused compound into an oxidation reactor and oxidizing the nitrogen-infused compound to form the nitrogen-containing fertilizer; and separating molecules within the nitrogen-containing fertilizer based on a size of the molecules and packaging smaller-sized molecules as a final fertilizer product.

Aspect 2: The method of aspect 1, wherein hydrolyzing the prepared starting material by applying heat and pressure to the reaction vessel containing the prepared starting material comprises applying a heat of about 100 to about 900 degrees Celsius and applying a pressure of about 1 atm to about 200 atm.

Aspect 3: The method of Aspect 1 or 2, wherein transferring the hydrolyzed carbon compound into a nitrogen infusion reactor comprises transferring the hydrolyzed carbon compound under high heat and high pressure.

Aspect 4: The method of any one of Aspects 1-3, wherein infusing the hydrolyzed carbon compound with the ionized nitrogen in a reaction vessel under high temperature and high pressure comprises subjecting the reaction vessel to a temperature of at least 250 degrees Celsius and a pressure of at least 80 atmospheres.

Aspect 5: The method of any one of Aspects 1-4, wherein the final fertilizer product has a salt index of less than 40.

Aspect 6: The method of any one of Aspects 1-4, wherein the final fertilizer product has a salt index of about 5 to about 40.

Aspect 7: A method of forming a fertilizer, the method comprising:
hydrolyzing a starting material to form a hydrolyzed carbon compound, the starting material comprising one or more of: a carbon-carbon bond and a carbon-hydrogen bond;
infusing the hydrolyzed carbon compound with nitrogen under high temperature and high pressure to form a nitrogen-infused compound; and
oxidizing the nitrogen-infused compound to form the fertilizer.

Aspect 8: The method of forming a fertilizer of Aspect 7, wherein the starting material contains at least one of: an alkene, an alkyne, an alkyl, an alkane, an aromatic ring structure, a carboxyl, a carbonyl, an acyl, an alcohol, a phenol, an amine, a carbohydrate, and a heterocyclic compound.

Aspect 9: The method of forming a fertilizer of Aspect 7 or Aspect 8, wherein the method further comprises separating nitrogen gas and oxygen gas from atmosphere to obtain separated nitrogen and separated oxygen, and wherein oxidizing the nitrogen-infused compound to form the fertilizer comprises injecting the separated oxygen into a reaction vessel.

Aspect 10: The method of forming a fertilizer of any one of Aspects 7 through 9, wherein the method further comprises ionizing the separated nitrogen to form ionized nitrogen and wherein infusing the hydrolyzed carbon compound with nitrogen under high temperature and high pressure to form a nitrogen-infused compound comprises injecting the ionized nitrogen into a reaction vessel.

Aspect 11: The method of forming a fertilizer of any one of Aspects 7 through 10, wherein the fertilizer has a salt index of less than 40.

Aspect 12: The method of forming a fertilizer of any one of Aspects 7 through 10, wherein the fertilizer has a salt index of about 5 to about 40.

Aspect 13: The method of forming a fertilizer of any one of Aspects 7 through 12, wherein infusing the hydrolyzed carbon compound with nitrogen under high temperature and high pressure comprises infusing at a temperature of at least 250 degrees Celsius and a pressure of at least 80 atmospheres.

Aspect 14: A fertilizer formed by the following method:
hydrolyzing a starting material, the starting material comprising at least one of a carbon-carbon bond and a carbon-hydrogen bond, to form a hydrolyzed carbon compound;
infusing the hydrolyzed carbon compound with nitrogen under high temperature and high pressure to form a nitrogen-infused compound; and
oxidizing the nitrogen-infused compound to form the fertilizer.

Aspect 15: The fertilizer of Aspect 14, wherein the starting material contains at least one of: an alkene, an alkyne, an alkyl, an aromatic ring structure, a carboxyl, a carbonyl, an acyl, an alcohol, a phenol, an amine, a carbohydrate, a plastic, and a heterocyclic compound.

Aspect 16: The fertilizer of Aspect 14 or Aspect 15, wherein the method further comprises separating nitrogen gas and oxygen gas from atmosphere to obtain separated nitrogen and separated oxygen, and wherein oxidizing the nitrogen-infused compound to form the fertilizer comprises injecting the separated oxygen gas into a reaction vessel.

Aspect 17: The fertilizer of any one of Aspects 14-16, wherein the method further comprises ionizing the separated nitrogen to form ionized nitrogen and wherein infusing the hydrolyzed carbon compound with nitrogen under high temperature and high pressure to form a nitrogen-infused compound comprises injecting the ionized nitrogen into a reaction vessel.

Aspect 18: The fertilizer of any one of Aspects 14-17, wherein the fertilizer has a salt index of about 5 to about 40.

Aspect 19: A nitrogen-based fertilizer comprising a hydrolyzed carbon compound infused with nitrogen, wherein the nitrogen-based fertilizer has a salt index from between about 5 to about 40.

Although the foregoing disclosure provides many specifics, such as use of the system in nitrogen-based fertilizers, it will be appreciated that pools, and other water holding devices are contemplated and these should not be construed as limiting the scope of any of the ensuing claims. Other embodiments and configurations may be devised which do not depart from the scopes of the claims. Features from different embodiments and configurations may be employed separately or in combination. Accordingly, all additions, deletions and modifications to the disclosed subject matter that fall within the scopes of the claims are to be embraced thereby. The scope of each claim is indicated and limited only by its plain language and the full scope of available legal equivalents to its elements.

Furthermore, if any references have been made to patents and printed publications throughout this disclosure, each of these references and printed publications are individually incorporated herein by reference in their entirety.

1. A method of forming a nitrogen-containing fertilizer, the method comprising:
preparing a starting material by grinding the starting material into a powder to increase surface area for further processing and to form a prepared starting material, wherein the starting material is selected from the group of corn, wood, carbohydrates, alcohols, plastics, and oils;
hydrolyzing the prepared starting material by applying heat and pressure to a reaction vessel containing the prepared starting material and water, to form a hydrolyzed carbon compound;
ionizing nitrogen gas using an electric-magnetic ionization system to form ionized nitrogen;
transferring the hydrolyzed carbon compound into a nitrogen infusion reactor;
infusing the hydrolyzed carbon compound with the ionized nitrogen in a reaction vessel under high temperature and high pressure to form a nitrogen-infused compound;
transferring the nitrogen-infused compound into an oxidation reactor and oxidizing the nitrogen-infused compound to form the nitrogen-containing fertilizer; and
separating molecules within the nitrogen-containing fertilizer based on a size of the molecules and packaging smaller-sized molecules as a final fertilizer product.

2. The method of claim 1, wherein hydrolyzing the prepared starting material by applying heat and pressure to the reaction vessel containing the prepared starting material comprises applying a heat of about 100 to about 900 degrees Celsius and applying a pressure of about 1 atm to about 200 atm.

3. The method of claim 1, wherein transferring the hydrolyzed carbon compound into a nitrogen infusion reactor comprises transferring the hydrolyzed carbon compound under high heat and high pressure.

4. The method of claim 1, wherein infusing the hydrolyzed carbon compound with the ionized nitrogen in a reaction vessel under high temperature and high pressure comprises subjecting the reaction vessel to a temperature of at least 250 degrees Celsius and a pressure of at least 80 atmospheres.

5. The method of claim 1, wherein the final fertilizer product has a salt index of less than 40.

6. The method of claim 1, wherein the final fertilizer product has a salt index of about 5 to about 40.

7. A method of forming a fertilizer, the method comprising:
hydrolyzing a starting material to form a hydrolyzed carbon compound, the starting material comprising one or more of: a carbon-carbon bond and a carbon-hydrogen bond;
infusing the hydrolyzed carbon compound with nitrogen under high temperature and high pressure to form a nitrogen-infused compound; and
oxidizing the nitrogen-infused compound to form the fertilizer.

8. The method of forming a fertilizer of claim 7, wherein the starting material contains at least one of: an alkene, an alkyne, an alkyl, an alkane, an aromatic ring structure, a carboxyl, a carbonyl, an acyl, an alcohol, a phenol, an amine, a carbohydrate, a plastic, and a heterocyclic compound.

9. The method of forming a fertilizer of claim 7, wherein the method further comprises separating nitrogen gas and oxygen gas from atmosphere to obtain separated nitrogen and separated oxygen, and wherein oxidizing the nitrogen-infused compound to form the fertilizer comprises injecting the separated oxygen into a reaction vessel.

10. The method of forming a fertilizer of claim 9, wherein the method further comprises ionizing the separated nitrogen to form ionized nitrogen and wherein infusing the hydrolyzed carbon compound with nitrogen under high temperature and high pressure to form a nitrogen-infused compound comprises injecting the ionized nitrogen into a reaction vessel.

11. The method of claim 7, wherein the fertilizer has a salt index of less than 40.

12. The method of claim 7, wherein the fertilizer has a salt index of about 5 to about 40.

13. The method of claim 7, wherein the step of infusing the hydrolyzed carbon compound with nitrogen under high temperature and high pressure comprises infusing at a temperature of at least 250 degrees Celsius and a pressure of at least 80 atmospheres.

14. A fertilizer formed by the following method:
hydrolyzing a starting material, the starting material comprising at least one of a carbon-carbon bond and a carbon-hydrogen bond, to form a hydrolyzed carbon compound;
infusing the hydrolyzed carbon compound with nitrogen under high temperature and high pressure to form a nitrogen-infused compound; and
oxidizing the nitrogen-infused compound to form the fertilizer.

15. The fertilizer of claim 14, wherein the starting material contains at least one of: an alkene, an alkyne, an alkyl, an aromatic ring structure, a carboxyl, a carbonyl, an acyl, an alcohol, a phenol, an amine, a carbohydrate, a plastic, and a heterocyclic compound.

16. The fertilizer of claim 14, wherein the method further comprises separating nitrogen gas and oxygen gas from atmosphere to obtain separated nitrogen and separated oxygen, and wherein oxidizing the nitrogen-infused compound to form the fertilizer comprises injecting the separated oxygen gas into a reaction vessel.

17. The fertilizer of claim 16, wherein the method further comprises the step of ionizing the separated nitrogen to form ionized nitrogen and wherein the step of infusing the hydrolyzed carbon compound with nitrogen under high temperature and high pressure to form a nitrogen-infused compound comprises injecting the ionized nitrogen into a reaction vessel.

18. The fertilizer of claim 14, wherein the fertilizer has a salt index of about 5 to about 40.

19. A nitrogen-based fertilizer formed from the method of claim 14, the nitrogen-based fertilizer comprising a hydrolyzed carbon compound infused with nitrogen, wherein the nitrogen-based fertilizer has a salt index from between about 5 to about 40.

20. The nitrogen-based fertilizer of claim 19, wherein the nitrogen-based fertilizer is formed using renewable materials as the starting material.
